(19) United States
(12) Patent Application Publication
(10) Pub. No.: US 2005/0125385 A1
(43) Pub. Date: Jun. 9, 2005

(54) Framework enabling access of data from disparate databases in a manufacturing plant

(75) Inventors: Ravi Bommegowda, Bangalore (IN); Anand Shankar, Bangalore (IN); Arundathi Pawar, Bangalore (IN); Thomas Marks, Fort Washington, PA (US)

Correspondence Address: HONEYWELL INTERNATIONAL INC., 101 COLUMBIA ROAD, P O BOX 2245, MORRISTOWN, NJ, 07962-2245, US

(73) Assignee: Honeywell International, Inc., Morristown, NJ (US)

(21) Appl. No.: 10/728,433

(22) Filed: Dec. 8, 2003

(51) Int. Cl. G06F 17/30

(52) U.S. Cl. 707/3

(57) ABSTRACT

A framework facilitating the implementation of access of data from disparate databases accessible by corresponding user applications. The framework includes pre-specified procedures (contained in corresponding interfaces) which may be easily implemented on a user application to enable access of other databases accessible through other applications, as well as providing other applications access to the databases accessible from the user application. According to another aspect of the present invention, a user may specify an operation associated with the displayed data, and the operation is executed on the displayed data.

### BACKGROUND OF THE INVENTION

1. Field of the Invention

The present invention generally relates to control systems used in manufacturing plants, and more specifically to a method and apparatus for enabling access of data from disparate databases in a manufacturing plant.

2. Related Art

A manufacturing plant (e.g., oil refinery, power plants, pharmaceutical plant, etc.) generally contains several field devices connected to a control system, which together implement a desired manufacturing process by controlling the operation of various equipment. Each field device in turn contains components such as sensors (which measure various variables such as temperature, flow, pressure, etc.), control elements (e.g., valves, switches), and transmitters (which transmit any desired information to the control system, which controls the manufacturing process). For example, field devices containing pressure sensors may be monitored and valves controlled to maintain the pressure level in a boiler (example of equipment) at a desired value.

Manufacturing plants often contain multiple databases, with each potentially containing some overlapping data with other database(s). For example, a portion of a manufacturing plant may be implemented using a control system provided by one vendor and another portion of the plant being implemented using another control system provided by another vendor. Similarly, different user applications may maintain data in the corresponding database, even though the applications are provided by the same vendor. Each control system may maintain control data representing (or controlling) the corresponding manufacturing processes in a corresponding database. Similarly, other databases may be maintained for various configuration information, change management (i.e., configuration changes) related information, status information, etc. Accordingly, it may be appreciated that the entire data is fragmented across multiple databases.

One problem with such fragmentation of data is that an user may not be able to access all data of interest from a single client system (or a corresponding user application) designed to operate only with a corresponding database. For illustration, an operation application used by an operator may be designed to access data representing the present value of a variable. Assuming that the value requires further investigation (for example, because the value is in an unexpected range), the operator may wish to examine the various strategies that affect the parameter value, preferably from the same user application from which the variable is examined. In general, it may be desirable to provide access to data from different databases from several user applications (which may be tailored for specific tasks such as configuration, inventory management, etc).

### SUMMARY

In one embodiment, a framework is provided which enables a new user application to access data in multiple databases which are accessible through corresponding user applications executing on corresponding client systems in a manufacturing plant. A first plurality of procedures are provided according to a first interface on each of the client systems. The first plurality of procedures enable retrieval of desired data from a corresponding database accessible from the corresponding user application implemented on the corresponding client system.

An access module is also provided, which can be instantiated from the new user application. The access module provides a convenient user interface using which a user may specify a search query on any of the databases. The access module uses the first plurality of procedures to retrieve data matching the query. Thus, by instantiating the access module from the new user application, a user can access data on any of the databases.

The framework may further include a second plurality of procedures according to a second interface. The second plurality of procedures enable the access module to initiate and terminate an instance of said means for access. By defining procedures according to such interfaces and implementing the procedures on client systems/access modules, the framework simplifies addition of a new user application to a group of user applications from which any database can be potentially accessed.

The framework may be used to enable a user to execute an operation on the displayed data. In one embodiment, a third plurality of procedures according to a third interface are implemented in the access module. The third plurality of procedures enable the access block to communicate an operation selected by a user (using a convenient user interface). An identifier of the selected operation may be provided to the user application which has retrieved the data from the database, and the operation is executed by the user application.

Further features and advantages of the invention, as well as the structure and operation of various embodiments of the invention, are described in detail below with reference to the accompanying drawings. In the drawings, like reference numbers generally indicate identical, functionally similar, and/or structurally similar elements. The drawing in which an element first appears is indicated by the leftmost digit(s) in the corresponding reference number.

### BRIEF DESCRIPTION OF THE DRAWINGS

The present invention will be described with reference to the accompanying drawings which are described briefly below.

FIG. 1 is a block diagram illustrating an example environment in which the present invention can be implemented.

FIG. 2 is a screen illustrating the manner in which a user may specify search criteria in one embodiment.

FIG. 3 is a block diagram illustrating the manner in which a framework, which enables easy implementation of access to various databases through corresponding user applications, according to an aspect of the present invention.

FIG. 4 is a screen illustrating a manner in which an user may select an operation of interest in one embodiment.

FIG. 5 is a block diagram illustrating the manner in which an execution block performs the specified operation according to an aspect of the present invention.

FIG. 6 is a block diagram illustrating the details of a digital processing system implemented substantially in the form of software in an embodiment of the present invention.

### DETAILED DESCRIPTION

1. Overview

An aspect of the present invention provides an access module which enables data available in different databases to be accessible from any user application (or client system executing the user application). In one embodiment, a corresponding set of interfaces are provided on each of the client systems (which are already implemented to access only respective database), which can be used through the access module to retrieve any data of interest. The access module can be executed from any client system/user application, and the user is provided a convenient user interface using which a search query and a database of interest can be specified, and the access module uses the set of interfaces to retrieve data by interfacing the specific client systems/user applications which are already designed to access the database of interest.

One more aspect of the present invention provides an access module usable in the form a framework, which facilitates data available from various pre-existing databases (via corresponding pre-existing user applications) to be accessible to a new user application/client system, and also access of data (on databases) available via the new user application to pre-existing user applications. Such a feature is enabled by defining interfaces which can be used by the user applications in conjunction with the access module. Each interface may contain a set of procedures, which need to be implemented by each user application, and another set of procedures which are implemented by the access module. The access module invokes the set of procedures implemented by a user application to retrieve data accessible via the user application, and the user applications may invoke the procedures implemented by the access module. As a result, the ability to access the data on databases may be easily extended to new user applications easily.

According to another aspect of the present invention, an execution module enables an user to execute an operation on a client system/user application using data previously retrieved from potentially another (but usually the same) client system/user application. In an embodiment, the access module (instantiated by the execution module) enables an user to specify a specific desired operation associated with the displayed data and the client system/user application on which to execute the operation, and passes the displayed data and identifiers of the desired operation back to the execution module. The execution module causes the operation to be performed by the specified client system/user application.

Several aspects of the invention are described below with reference to examples for illustration. It should be understood that numerous specific details, relationships, and methods are set forth to provide a full understanding of the invention. One skilled in the relevant art, however, will readily recognize that the invention can be practiced without one or more of the specific details, or with other methods, etc. In other instances, well-known structures or operations are not shown in detail to avoid obscuring the invention.

2. Example Environment

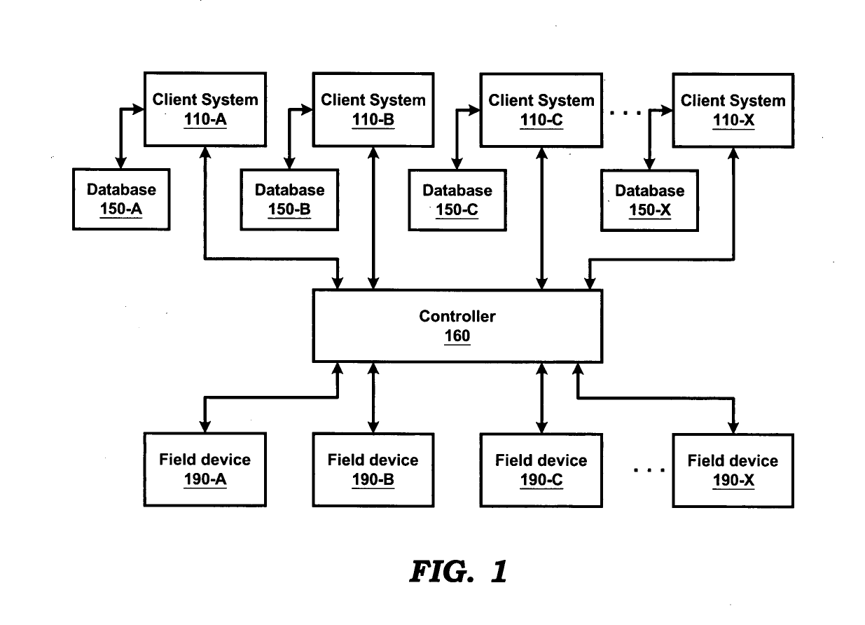

FIG. 1 is a block diagram illustrating an example environment in which the present invention can be implemented. The block diagram is shown containing client systems 110-A through 110-X, databases 150-A through 150-X, controller 160 and field devices 190-A through 190-X. Each system is described below in further detail.

Field devices 190-A through 190-X contains components such as sensors (which measure various variables such as temperature, flow, pressure, etc.), control elements (e.g., valves, switches), and transmitters (which transmit any desired information to the control system, which controls the manufacturing process). Field devices 190-A through 190-X may be implemented in a known way.

Controller 160 receives data from corresponding field devices (e.g., sensors), processes the data in a pre-defined manner (e.g., according to a control algorithm) and generates a control signal. The control signal is then used to operate another field device (e.g., to open/close a control valve). Controller 160 may be implemented in a known way. Only one controller 160 is shown for conciseness, but multiple controllers may be present in an environment to implement different manufacturing processes or be provided by different vendors.

Each of the databases 150-A through 150-X stores data generated respectively by a corresponding user application. The data stored in a database may be retrieved only by a corresponding user application. F or example, a Control Builder (CB) application (executed in client system 110-A and provided by Honeywell International, the assignee of the subject application) may be used to configure a control loop and the corresponding data may be stored/retrieved in/from database 150-A by client system 110-A. Similarly, data bases 150-B through 150-X may be used to store/retrieve data respectively by client systems 110-B through 110-X in a known way.

Client systems 110-A through 110-X represent digital processing systems on which various user applications related to operation/control of manufacturing processes, are implemented. Merely for illustration, it is assumed that each client system implements a single user application. For example, client system 110-A may support Control Builder (CB) application noted above, and another client system may be used to implement Quick Builder application, also available from Honeywell International. Each of the two user applications may be used to configure a corresponding control system in a manufacturing plant. Client systems 110-B through 110-X may similarly support applications available from different vendors.

Thus, it maybe appreciated that each client system may be able to access data related to only the corresponding database, and not the data in the others. It may be desirable to provide each client system (or an user using the client system) the ability to access data related to all databases. An aspect of the present invention provides a frame-work using which such access can be provided, as described in sections below in detail. Such a feature is referred to as an access feature in the description below.

According to another aspect of the present invention, an execution block may invoke the access block to enable an user to retrieve/display data from a database of interest and execute an operation of interest using the retrieved data. As described below, the access block may send to the execution block the displayed data and an identifier of the operation, and the execution block may interface with the user application to cause the operation executed by the user application. Such a feature is referred to as an execution feature in the description below. The execution feature may be built on top of the access feature, and accordingly the manner in which the access feature may be used and implemented is described first.

3. Access Feature

Broadly, an aspect of the present invention provides a framework using which potentially every database can be accessed from every user application. In an embodiment described below, an access module is provided associated with each user application (used for the operation/control of manufacturing processes) to provide the access feature. The access module on each user application may broadly provide the below sub-features:
(A) provide an interface using which an user can specify different data portions of interest provided on different databases;
(B) send request for data to an user application having the ability to access data from the specified database;
(C) receive a response and display the received data; and
(D) enable an access module executed on another user application to send requests for data present on a database the user application is already able to interface with, and generate responses corresponding to the requests.

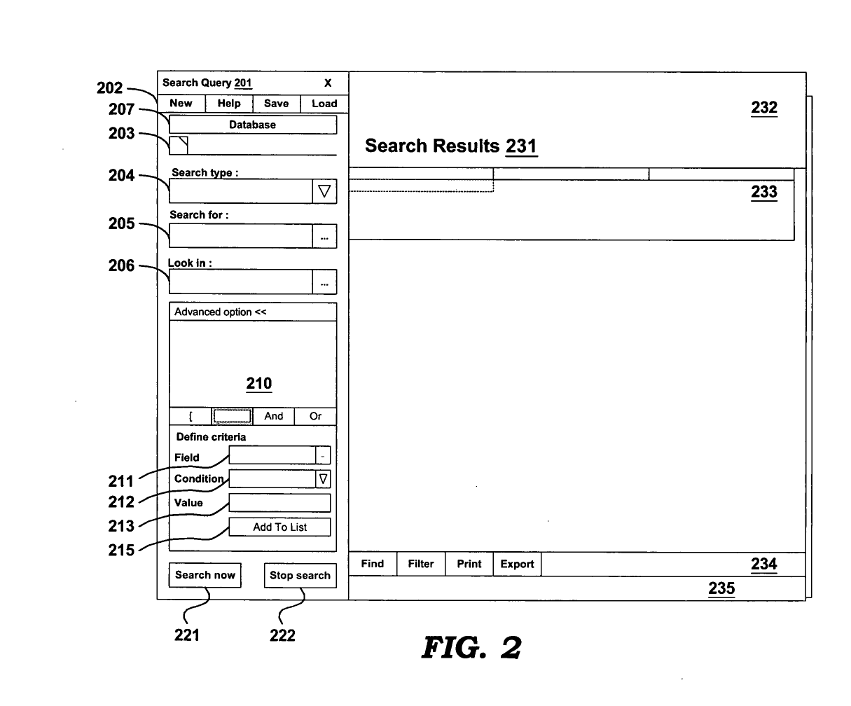

Sub-features (A) and (C) are described below with reference to example screens of FIGS. 2A and 2B. For illustration, it is assumed that an user executes an access module on client system 110-B, and retrieves data from database 150-A by interfacing with client system 110-A. However, access module may retrieve data from other databases as well.

FIG. 2A is a screen illustrating an example user interface using which an user may specify a desired search criteria using. Broadly, the operation is described below with reference to screen 200. Screen 200 is shown containing two portions: ‘Search Query 201’ and ‘Search Results 231’. Broadly, an user enters various search criteria in the search query portion, and the corresponding results are displayed in search results 231 portion.

Search Query 201 is shown containing ‘Tool Bar 202’, ‘Title 203’, ‘Search Type 204’, ‘Search For 205’, ‘Look In 206’, ‘database 207, ‘Advanced Options 210’, ‘Add To List 215’, ‘Search Now 221’, and ‘Stop Search 222’. Tool Bar 202 provides options: ‘New’ (to clear the entered search criteria and to accept a new search criteria), ‘Save’ (to save the present search criteria), ‘Load’ (to load a previously stored search criteria), and ‘Help’ (a knowledge base describing the manner in which access module may be used). Title 203 displays the search type chosen by an user, and can be used to go back to a previously performed search (using the ‘Add to list 215’ option described below).

Database 207 is used to specify the specific database in which the search is to be performed. It may be appreciated that the options in the remaining fields are determined by the selection of the database. In an embodiment, the databases that can be searched are specified in a configuration file (along with other information as described below), and the user may select one of the databases.

Search Type 204 specifies the type of search. The choice of types may also be determined based on the content of the configuration file, and a drop down menu may a low a user to select from one of the types. For example, search types may includes “Where all a tag is used”, “Search for tags based on parameter value”, etc. As is well known in the relevant arts, tags are specified and configured while defining a manufacturing process. Search For 205 field may be used to specify the specific value to be searched for.

Look In 206 field may be used to specify various groups within the selected database. The available groups within a database may be indicated by the configuration file, as noted above.

Three entries, Field 211 (column to be searched), condition 212 (e.g., and, or), and value 213 are provided to define a custom search criteria, and the search is displayed in ‘Advanced Options 210’. ‘Add To List 215’ option may be selected to add the search criteria represented by fields 211-213 to the present search (displayed in advanced options 210). ‘Search Now 221’ may be selected to initiate a search and ‘Stop Search 222’ may be selected to stop an on-going search. The results of the search are provided in ‘search results 231’ portion. A customize view field (not shown) may be provided to enable a user to select the specific columns of interest to display in the search results. The available columns (in the selected database) may again be indicated by configuration file.

Thus, interfaces such as above may be provided to enable an user to specify the desired search criteria, and to display the corresponding results. The manner in which access module can be implemented to provide such features are described below in further detail.

4. Access Module

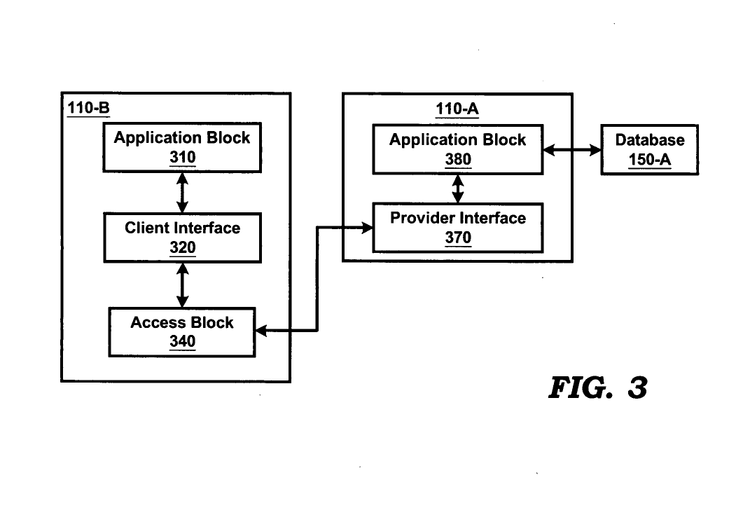

The operation and implementation of access modules is described continuing with respect to above example in which an user of an user application on client system 110-B may access desired data on database 150-A through client system 110-A. The manner in which access module may be implemented is described below with reference to FIG. 3.

FIG. 3 is a block diagram illustrating the details of an access module implementing access feature according to an aspect of the present invention. The block diagram is shown containing application block 310, client interface 320 and access block 340 in client system 110-B, provider interface 370 and application block 380 in client system 110-A, and database 150-A.

Client interface 310, access block 340 and provider interface 370 represent various components of the access module. It should be understood that client interface 310 and access block 340 are shown in one client system and provider interface is shown in another system merely for illustration. All the three components can be implemented in the same client system at least to the extent an user application provides both the ability to access data in other databases, and also provides other access modules access to the data the client system can access.

Application blocks 310 and 380 represent the software instructions (when executed) providing the respective user applications. Application block 380 is shown connected to database 150-A, indicating that the corresponding user application can access database 150-A. In addition, application block 310 enables a user to instantiate the access block while the user is operating with (e.g., with a GUI provided by) the corresponding user application. As a result, the user may view data from various databases using a single user application.

Client interface 320 represents a set of interfaces which can be invoked by application block 310 to instantiate and use access module 340. Thus, application block 310 may need to be designed to invoke the appropriate interface to instantiate the access block 340 at a desired time. Similarly, client interface 320 also represents the set of interfaces access interface 340 may invoke to communicate with application block 310.

In one embodiment, each (or some) window displayed by an user application provides an option to instantiate access block 340. Thus, when the user selects an appropriate option, application block 310 invokes the appropriate interface to instantiate access block 340. When instantiated, the display of FIG. 2 may be generated.

Provider interface 370 represents a set of interfaces which can be invoked (e.g., by access block 340) to request data available on database 380. Thus, using such interfaces, access block 340 may access data available on database 150-A. Once the data is received, access block 340 may display the received data in search results 231 portion described above.

Access block 340 contains the software instructions implementing the various interfaces which can be invoked by application block 310. In addition, access block 340 contains the software instructions to provide the appropriate user interface (as described above with reference to FIG. 2). Access block 340 may also invoke interfaces provided by provider interface 370 to retrieve data from database 150-A.

Thus, to enable an user to access data from various applications, the corresponding application blocks (such as 310) may need to be extended to invoke the appropriate interface(s) implemented by access block 340. In addition, application blocks (such as 380) need to be extended to implement the interfaces invoked by access block 340 consistent with provider interface 370. The implementation of such extensions depends on the design and the environment in which each application block is implemented, and will be apparent to one skilled in the relevant arts

Due to the operation according to pre-specified interfaces, access block 340 can be deployed onto each client system with relative ease. Similarly, extensions to application blocks can also be implemented easily due to the use of the pre-specified interfaces provided according to the framework.

Accordingly, the framework provides a easy/quick way to enable an user to access data provided on different databases from any of the user applications. An user may retrieve related data from two different databases (using different user applications), and compare the data (e.g., for consistency across different databases). The framework can be extended to the execution feature noted above.

5. Execution Feature

In an embodiment, the execution feature is provided by using an execution block provided on client system 110-X. Broadly, the execution block may enable an user to instantiate the access block by appropriate user interface, and retrieve data of interest from database by keying-in the desired search query. The access block may be extended to display the operations that are possible on the displayed data. The user may select one of the operations. The displayed data and the selected operation are passed back to the execution block.

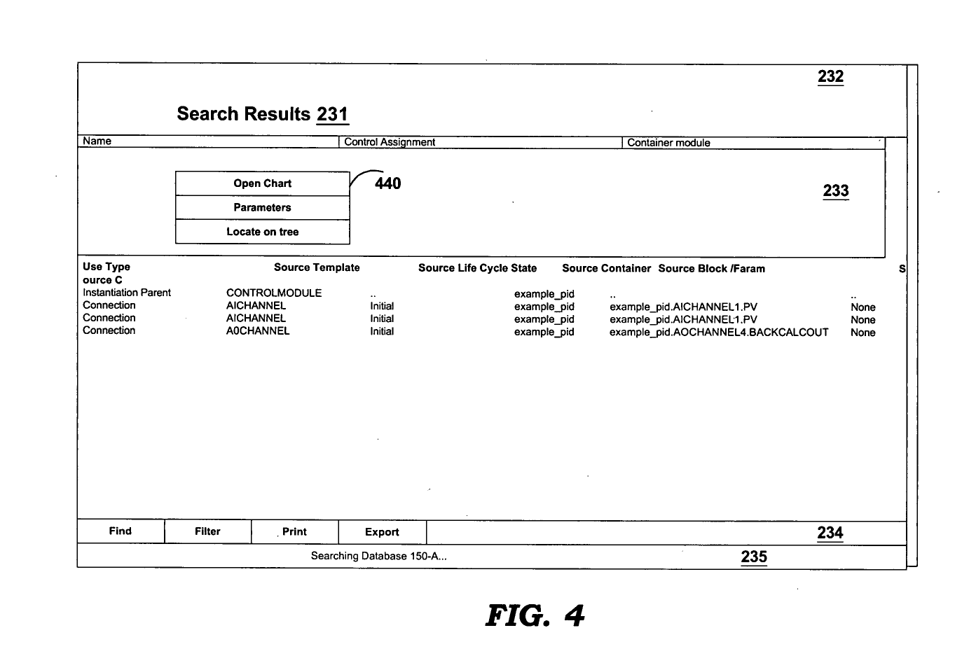

The execution block interfaces with the user application (which has retrieved the data from the database), and causes the selected operation to be executed. The manner in which an user may be enabled to specify an operation of interest is described below with reference to FIG. 4.

FIG. 4 is a screen illustrating the manner in which an user may select an operation of interest according to an aspect of the present invention. FIG. 4 is shown depicting applications menu 440 on top of search results 231 portion. The search results may correspond to a search executed using an interface such as that described in FIG. 2.

Application menu 440 may be implemented as a ‘pop-up’ menu, which is displayed upon a pre-specified user action (e.g., right clicking on displayed data). Applications Menu 440 contains a list of operations that may be performed by a corresponding user application. An user may select an operation (e.g, ‘Open Chart’ operation may be selected and is shown in dark)from the Applications Menu 440.

The selected operation is executed using the execution block as described below in further detail.

6. Execution Block

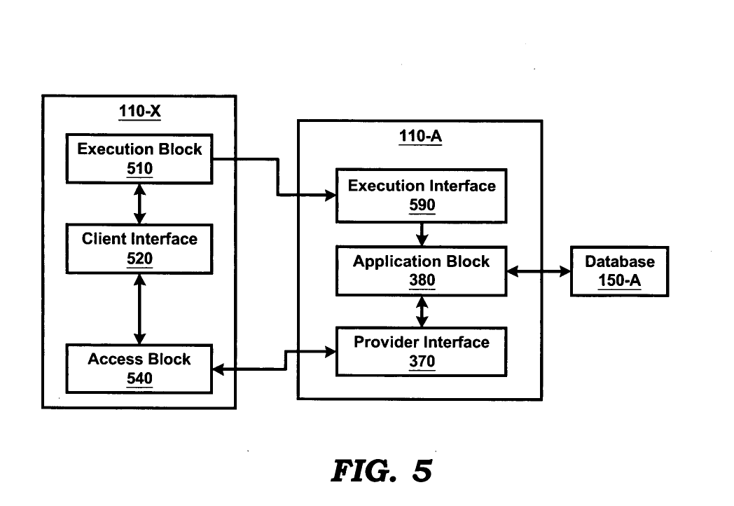

FIG. 5 is a block diagram illustrating the manner in which an execution block implemented according to an aspect of the present invention can be used to perform a desired operation. The diagram corresponds to a situation in which the execution block provided on client system 110-X enables an user to access data on client system 110-A, specify an operation to be performed, and have the operation executed on client system 110-A.

The block diagram is shown containing execution block 510, execution interface 590, and access block 540 within client system 110-X. The block diagram further includes client system 110-A containing execution interface 590 in addition to application block 380 and provider interface 370 already noted above with reference to FIG. 3. Only the extension and/or differences with reference to FIG. 3 are described below for conciseness.

Access block 540 may be implemented similar to access block 340 of FIG. 3, and thus can be used by execution block 510 to provide a suitable user interface to retrieve data from client system 110-A. The retrieved data may be displayed for the user. The user may use the displayed data, for example, to compare similar data from multiple user applications.

In addition, access block 540 may provide an interface such as that described above with reference to FIG. 4 to display for an user the possible operations that may be performed on the displayed data. In an embodiment, the list of possible operations that may be performed on data related to each database, is provided in an XML file, and is made available to access block 540. Once the user selects the operation of interest, access block 540 may pass the selected operation and the displayed data back to execution block 510.

Execution block 510 receives (via client interface 520)a specified operation (selected by an user) and the data (on which to perform the operation) from access module 350. Execution block 510 interfaces with application block 380 according to execution interface 590 to have execution block 380 execute the specified operation. With respect to execution feature, execution interface 590 may indicate the specific manner in which the specified operation is communicated to application block 380.

Application block 380 receives an identifier of the specified operation according to execution interface 590, and performs the operation. In an embodiment described below, the data on which to perform the operation is specified by a data identifier (e.g., tag name in FIG. 4). Application block 380 retrieves the data from database 150-A using the data identifier and executes the operation using the data. Alternatively, application block 380 receives all the data rows (one row at a time, for example, in XML format).

Application block 380 may be automatically re-instantiated if the user application is not active (i.e., already terminated). The manner in which an user application (in client system 110-A) can be instantiated depends generally on the environment (e.g., operating system, hardware platform) in which the user application is implemented, and accordingly the instantiation may be performed in a known way.

In an embodiment, many of the user applications are provided on the same hardware platform. Accordingly, even though the description is provided with reference to accessing data from one client system and performing operation on another client system, an user may view the results of execution of the operation on the same hardware platform. Thus, client systems 110-A and 110-X in such a scenario represent the same hardware platform.

Thus, an aspect of the present invention enables an user to execute a desired operation using user applications which already have the ability to access the data in databases. It may be further appreciated that deploying the features above is simplified due to the use of various interfaces defined according to the framework. The description is continued with reference to the details of such interfaces for both the access feature and the execution feature together.

7. Interfaces in General

In one embodiment, the access module, execution module, and user applications are implemented in net environment (defined by Microsoft Corporation). In such an environment, each interface noted above defines one or more methods (referred to as ‘procedures’ hereafter). Thus, one of the modules ‘implements’ (i.e., contains the software instructions) a procedure, and another module ‘invokes’ (calls) the procedure.

The interfaces thus defined form the basis of various features of the present invention described above. Broadly, the interfaces may be grouped into three categories:
1. Initialization/termination group;
2. Communication group; and
3. Data access group.

Each group is described below in further detail. The implementation of the various procedures noted below depends on the specific environments, and will be apparent to one skilled in the relevant arts by reading the disclosure provided herein.

8. Initialization/Termination Group

The initialization/termination group contains various procedures provided to start (initialize or instantiate) the access block (340 or 540) described above. First, the procedures implemented in/by the access block, and invoked by application block 310 or execution block 510 are described below.

A Launch Browser( ) procedure may be invoked at the appropriate time (e.g., in response to an user action) to provide the window-based-interfaces (or graphical user interface, GUI, in general) described above with reference to FIGS. 2 and 4. A StopBrowser( ) procedure may be invoked (for example when application block 310 is terminating) to terminate the GUI.

A Login( ) procedure may be invoked to provide (to access block) the authentication information (e.g., password) and the database identifier. The information is used for retrieving data from the corresponding database (in a known way).

A LoadConfigFile( ) procedure may be used to provide various configuration information to the access block. The configuration information may indicate all the databases from which data can be accessed and/or operations performed, the specific operations supported by each database (or corresponding user application), the specific columns available in the database, etc.

An Advice( ) procedure may specify (to the access block) the specific instance of the client interface which needs to be used by the access block for future communications. Thus, an identifier (or interface name in the specific embodiment) of the interface is provided to the access block. As a result, an application block can potentially communicate with multiple databases in a single session. An UnAdvice( ) procedure is used to indicate that the application/execution block is about to terminate and thus, the instance of the client interface cannot be used anymore.

While the procedures invoked by application/access block are described above, there may be procedures invoked by access block 340/540 and implemented by application block 310 according the framework. For example, a NotifyBrowserClose( ) procedure may be used to indicate to the application block that the access block (or GUI provided thereby) is about to terminate.

Once a GUI is initialized, data may be retrieved from the application blocks. According to the framework provided in accordance with an aspect of the present invention, access block uses pre-specified interface (provider interface 370) to indicate the search criteria, and application block 380 converts the search criteria consistent with the format required by database 150-A. Accordingly, an example implementation of provider interface 370 is described below.

9. Database Access Group

Provider interface 370 implements various procedures that can be invoked by access block 340 to retrieve data from database 150-A. A InitializeProvider( ) procedure may be used while establishing a connection with the database. Since an user application may be able to connect to multiple databases, the database identifier and password may be passed as parameters. A file name, indicating various pieces of configuration information as noted above, may be passed to provider interface 370 using this procedure.

An ExecuteSearchQuery( ) may pass as a parameter the search query (e.g., in XML format), and cause the corresponding query executed on database 150-A. GetFirst( ) procedure is used to retrieve the first row, and GetNext( ) procedure a subsequent row. A StopProcessing( ) query terminates retrieval of the rows. A GetErrors( ) procedure is used to retrieve any errors generated while retrieving the rows.

Access block 340/540 may also implement other procedures which can be used either by execution/applications blocks (or non-GUI interfaces) to access data from the database. An Execute( ) procedure may cause access block 540 to retrieve data. The search criteria may be passed as a parameter string for the procedure. A Login( ) procedure (passing as parameters the database server name and the password) may be used for authentication.

10. Communications Group

As described above, access block 540 may need to indicate to execution block 510 the specific operation selected by the user and the presently displayed data. A EventNotifier( ) (implemented by execution block 510 and invoked by access block 540) procedure may be used to provide such an indication.

In an embodiment, instead of passing the entire displayed data, an identifier(e.g., tag name of ‘Source template’ in FIG. 4) which can be used by application block 380 to retrieve the same data again, is provided as a parameter of EventNotifier( ) procedure. Thus, the same identifier is passed from execution block 510 to application block 380. Application block 380 retrieves the data and performs the specified operation.

It should be understood that the procedures described above are merely intended to illustrative. As will be apparent to one skilled in the relevant arts, a more extensive/exhaustive/smaller set of interfaces (and procedure calls) may be implemented, as is suitable for the specific environments, without departing from the scope and spirit of the present invention. Such implementations are contemplated to be covered by various aspects of the present invention. The description is continued with reference to an example implementation implemented substantially in the form of software.

11. Software Implementation

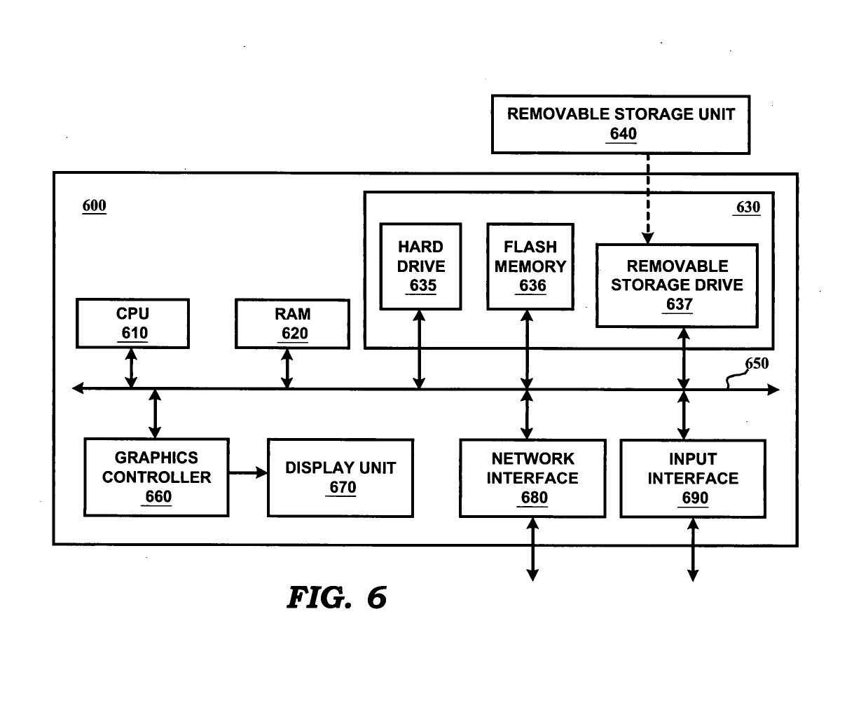

FIG. 6 is a block diagram illustrating the details of digital processing system 600 implemented substantially in the form of software in an embodiment of the present invention. System 600 may correspond to any of client systems 110-A through 110-X. System 600 may contain one or more processors such as central processing unit (CPU) 610, random access memory (RAM) 620, secondary memory 630, graphics controller 660, display unit 670, network interface 680, and input interface 690. All the components except display unit 670 may communicate with each other over communication path 650, which may contain several buses as is well known in the relevant arts. The components of FIG. 6 are described below in further detail.

CPU 610 may execute instructions stored in RAM 620 to provide several features of the present invention. CPU 610 may contain multiple processing units, with each processing unit potentially being designed for a specific task. Alternatively, CPU 610 may contain only a single general purpose processing unit. RAM 620 may receive instructions from secondary memory 630 using communication path 650. The instructions may implement one or more of the various user applications, access module, access module, procedures, etc., described above.

Graphics controller 660 generates display signals (e.g., in RGB format) to display unit 670 based on data/instructions received from CPU 610. Display unit 670 contains a display screen to display the images defined by the display signals. Input interface 690 may correspond to a key-board and/or mouse. In the case of access module 350, graphics controller 660 and input interface 690 enables an user to provide search criteria, view results, and select operations etc.

Secondary memory 630 may contain hard drive 635, flash memory 636 and removable storage drive 637. Secondary memory 630 may store the data and software instructions (e.g., methods instantiated by each of client system), which enable system 600 to provide several features in accordance with the present invention. Some or all of the data and instructions may be provided on removable storage unit 640, and the data and instructions may be read and provided by removable storage drive 637 to CPU 610. Floppy drive, magnetic tape drive, CD-ROM drive, DVD Drive, Flash memory, removable memory chip (PCMCIA Card, EPROM) are examples of such removable storage drive 637.

Removable storage unit 640 may be implemented using medium and storage format compatible with removable storage drive 637 such that removable storage drive 637 can read the data and instructions. Thus, removable storage unit 640 includes a computer readable storage medium having stored therein computer software and/or data.

In this document, the term “computer program product” is used to generally refer to removable storage unit 640 or hard disk installed in hard drive 635. These computer program products are means for providing software to system 600. CPU 610 may retrieve the software instructions, and execute the instructions to provide various features of the present invention as described above.

12. Conclusion

While various embodiments of the present invention have been described above, it should be understood that they have been presented by way of example only, and not limitation. Thus, the breadth and scope of the present invention should not be limited by any of the above described exemplary embodiments, but should be defined only in accordance with the following claims and their equivalents.

1. A computer readable medium carrying one or more sequences of instructions for causing a first client system to enable a user to access a plurality of databases through a corresponding plurality of client systems contained in a manufacturing plant, wherein each of said plurality of client systems is already designed to access data in a corresponding one of said plurality of databases, wherein execution of said one or more sequences of instructions by one or more processors causes said one or more processors to perform the actions of:
executing a user application which is related to operation/control of a manufacturing process in said manufacturing plant;
enabling said user to instantiate a user interface from said user application;
enabling said user to specify a database of interest and a search criteria using said user interface, wherein said database of interest is accessible via a second client contained in said plurality of client systems;
sending said search criteria to said second client;
receiving a corresponding response; and
displaying said corresponding response.

2. The computer readable medium of claim 1, further comprising:
enabling said user to specify an operation associated with data forming said corresponding response;
executing said operation.

3. The computer readable medium of claim 2, wherein said user interface is implemented in the form of an access module executed when said user instantiates said user interface, further comprising:
receiving data representing said operation in said user application; and
sending said data representing said operation and data representing said response to said second client, wherein said second client executes said operation using said response.

4. The computer readable medium of claim 3, wherein said data representing said response comprises an identifier of the data retrieved from said database of interest.

5. A computer readable medium carrying one or more sequences of instructions for enabling a new user application to access data in a plurality of databases accessible through a corresponding plurality of user applications executing on a corresponding plurality of client systems, wherein said new user application and said plurality of user applications are related to operation/control of a manufacturing process in a manufacturing plant, said computer readable medium comprising:
means for implementing a first plurality of procedures according to a first interface, wherein said first plurality of interfaces can be implemented on each of said plurality of client systems,wherein said first plurality of procedures enable retrieval of desired data from a corresponding database accessible from the corresponding user application implemented on the corresponding client system; and
means for access which can be instantiated from said new user application, wherein said means for access enables a user to specify a first database and a search query, wherein said first database is contained in said plurality of databases, wherein said means for access uses said first plurality of procedures to retrieve data matching said query.

6. The computer readable medium of claim 5, further comprising means for implementing a second plurality of procedures according to a second interface, wherein said second plurality of procedures enable said means for access to initiate and terminate an instance of said means for access.

7. The computer readable medium of claim 6, further comprising means for implementing a third plurality of procedures according to a third interface wherein said third plurality of procedures enable said access block to communicate an operation selected by said user, wherein said operation is executed on data accessed by said means for access.

8. The computer readable medium of claim 7, wherein said operation is executed on a user application which retrieves said data from the corresponding database.

9. A method of enabling a new user application to access data in a plurality of databases accessible through a corresponding plurality of user applications executing on a corresponding plurality of client systems, wherein said new user application and said plurality of user applications are related to operation/control of a manufacturing process in a manufacturing plant, said method comprising:
implementing a first plurality of procedures according to a first interface on each of said plurality of client systems, wherein said first plurality of procedures enable retrieval of desired data from a corresponding database accessible from the corresponding user application implemented on the corresponding client system; and
providing an access module which can be instantiated from said new user application, wherein said access module enables a user to specify a first database and a search query, wherein said first database is contained in said plurality of databases, wherein said access module uses said first plurality of procedures to retrieve data matching said query.

10. The method of claim 9, further comprising implementing a second plurality of procedures according to a second interface, wherein said second plurality of procedures enable said access module to initiate and terminate an instance of said access module.

11. The method of claim 10, implementing a third plurality of procedures according to a third interface wherein said third plurality of procedures enable said access block to communicate an operation selected by said user, wherein said operation is executed on data accessed by said access module.

12. The method of claim 11, wherein said operation is executed on a user application which retrieves said data from the corresponding database.

13. A method of enabling a first client system to access a plurality of databases through a corresponding plurality of client systems contained in a manufacturing plant, wherein each of said plurality of client systems is already designed to access data in a corresponding one of said plurality of databases, said method comprising:
executing a user application which is related to operation/control of a manufacturing process in said manufacturing plant;
enabling said user to instantiate a user interface from said user application;
enabling said user to specify a database of interest and a search criteria using said user interface, wherein said database of interest is accessible via a second client contained in said plurality of client systems;
sending said search criteria to said second client;
receiving a corresponding response; and
displaying said corresponding response.

14. The method of claim 13, said method further comprising:
enabling said user to specify an operation associated with data forming said corresponding response;
executing said operation.

15. The method of claim 14, wherein said user interface is implemented in the form of an access module executed when said user instantiates said user interface, said method further comprising:
receiving data representing said operation in said user application; and
sending said data representing said operation and data representing said response to said second client, wherein said second client executes said operation using said response.

16. The method of claim 15, wherein said data representing said response comprises an identifier of the data retrieved from said database of interest.
